(19) United States
(12) Patent Application Publication
(10) Pub. No.: US 2006/0129326 A1
(43) Pub. Date: Jun. 15, 2006

(54) System for continuous outcome prediction during a clinical trial

(76) Inventors: Paul Henri Braconnier, Sherwood Park (CA); Peter Silverstone, Edmonton (CA)

Correspondence Address: HOLLAND & KNIGHT LLP, 2099 PENNSYLVANIA AVE, N.W., WASHINGTON, DC, 20006, US

(21) Appl. No.: 11/009,578

(22) Filed: Dec. 10, 2004

(51) Int. Cl. G06F 19/00; G06Q 10/00; G06Q 50/00

(52) U.S. Cl. 702/19; 705/2

(57) ABSTRACT

The present invention provides a method, apparatus, and computer instructions for improved control of clinical trials. In a preferred embodiment, after a clinical trial is initiated, data is regularly cleaned and processed to statistically analyze the data. The outcome includes a predictive measure of the timing and level by which the study will achieve one or more statistically significant levels, allowing mid-course modifications to the study (e.g., in population size, termination, etc.). Modification can be planned as part of the initial protocol, using thresholds or other appropriate criteria relating to the statistical outcome, making possible pre-approved protocol changes based on the statistical findings. This process has significant implications for the management of clinical studies, including ensuring the minimum possible time and number of patients are used in clinical studies to either prove (or disprove) the clinical efficacy of drugs or treatments.

### TECHNICAL FIELD

The invention disclosed generally relates to medical data systems, and more specifically, a system for monitoring clinical trial progress for the approval of new drugs and medical products or procedures.

### BACKGROUND OF THE INVENTION

Developing new drugs to treat disorders is a highly regulated process. Before a drug can be tested for its efficacy in humans there has to be detailed testing in animals. Once a drug is authorized to proceed to human testing in the U.S. there are three phases of clinical studies. The first phase, Phase I, usually involves testing in a small number of individuals for safety aspects of the drug as well as initial testing of dosing tolerability. If a drug appears safe and well tolerated it can proceed to Phase II testing, where the drug is tested in patients who have the disorder being examined. Here some evidence of efficacy is sought as well as evidence of safety and tolerability in the patient group. The next phase of testing is Phase III. This involves several large clinical studies which attempt to determine if the drug actually is efficacious in the disorder being studied. If the drug is approved, any further studies are usually termed Phase IV and may address many aspects of the drug's efficacy or comparison to other available treatment options.

For each study carried out in Phases I-IV, a detailed study protocol is needed. This protocol typically details all aspects of the clinical study, including the population to be studied, the inclusion and exclusion criteria for patients able to take part in the study, roles and responsibilities of everyone taking part in the study, what is the clinical question being asked, and what are the measurement tools that will be used to determine the outcome to this question.

At the end of the study it is important to ensure that only appropriate data is used in the statistical analysis. For example, if the study protocol determined that only patients aged from 40 to 60 were included, it is necessary to ensure that this was indeed the case. The role of data management is to ensure that after the study is completed, and before a statistical analysis is carried out, that only appropriate and relevant data (“clean” data) is included in the study analysis and the final database, which is then locked so it cannot be altered.

One of the major aspects of designing a protocol is the pre-determination of how large the study needs to be to answer the study question. For example, if a new drug for high blood pressure is being developed and is being compared to a dummy drug (a placebo), the study question may want the blood pressure reading to decrease at least 20 mmHg (millimeters of mercury). Therefore, before a study is started a statistical calculation needs to be made to estimate how may patients will need to take the study drug at a particular dose to give a statistically significant difference from those patients taking placebo. It may, for example, be estimated from the available data that a dose of 10 mg (milligrams) of the study drug will decrease blood pressure by 20 mmHg, whereas the placebo group would be anticipated to have a decrease in blood pressure of only 5 mmHg. Therefore a statistically calculation, commonly referred to as a “power calculation,” would be made. Given these assumptions, it may, for example, predict that there needs to be at least a 100 patient population in each group for there to be a statistically significant difference. This is usually defined as the likelihood of something occurring (“p”) by chance less than 1 time in 20, which is expressed as p<0.05. The formal statistical analysis is applied to the clean data.

However, a problem with these power analyses, on which the clinical study size is based and the outcome depends, is that they are essentially educated guesses. Many things can cause the actual outcome to differ from the theoretical estimate. However, in order to safeguard the integrity of a study the data is “locked” until the study is completed. This can lead in turn to the result that when the study is finished and the statistical analysis is carried out, it is quite possible that the patient population in one or more groups was not enough to reach statistical significance. In order to avoid the costs associated with initiating a new study, it is common for study protocols to over-sample. But this in turn requires significantly more patients and expense in carrying out the study than is needed to reach a conclusion.

One suggestion for addressing this problem has been the use of a formal statistical analysis called an “interim analysis.” In order to perform an interim analysis, data from a pre-determined number of study participants is cleaned and a formal statistical analysis carried out while the study is ongoing. This is akin to a “snapshot” of the data, and has some utility in making outcome predictions. However, it has limitations regarding both the practicality of its approach as well as the impact that an interim analysis can have on subsequent statistical analysis. The most significant issue is that by carrying out an interim analysis, it may in fact have other statistical implications for later in the study which can complicate final analysis. In other words, it can bias the subsequent results by making partial information available early. Since only data up to that time point is included in the analysis, the results can be also misleading, as subsequent data values may differ a great deal from the original set used in any interim analysis, but no one has visibility to this until the final analysis is performed. In addition, there are significant cost and time expenses in preparing an interim analysis that make it hard to carry out in most studies. For these reasons interim analyses are not frequently carried out in clinical studies.

This inability to determine when a study can terminate and the number of patients actually required to statistically test the study question remains a major problem in clinical research. There is, therefore, a need for a better way to control clinical trials.

### DISCLOSURE OF THE INVENTION

The present invention provides just such a method, apparatus, and computer instructions for improved control of clinical trials. In a preferred embodiment, after a clinical trial is initiated, data is regularly cleaned and processed to statistically analyze the data. The outcome includes a predictive measure of the timing and level by which the study will achieve one or more statistically significant levels, allowing mid-course modifications to the study (e.g., in population size, termination, etc.). Modification can be planned as part of the initial protocol, using thresholds or other appropriate criteria relating to the statistical outcome, making possible pre-approved protocol changes based on the statistical findings. This process has significant implications for the management of clinical studies, including ensuring the minimum possible time and number of patients are used in clinical studies to either prove (or disprove) the clinical efficacy of drugs or treatments.

### BRIEF DESCRIPTION OF THE DRAWINGS

While the invention is defined by the appended claims, as an aid to understanding it, together with certain of its objectives and advantages, the following detailed description and drawings are provided of an illustrative, presently preferred embodiment thereof, of which:

FIG. 1 is a block diagram illustrating a clinical trial information system in accordance with an embodiment of the invention;

FIG. 2 is a flow chart of illustrative data entry and report operations according to the first embodiment of the invention; and

FIG. 3 is a flow chart of illustrative protocol definition and revision operations according to the first embodiment of the invention.

### DESCRIPTION OF THE PREFERRED EMBODIMENT

In a preferred embodiment of the invention, a system is provided for continuously monitoring the likely outcome of a clinical trial. This process has significant implications for the management of clinical studies, and may dramatically alter how clinical studies are carried out. This can have benefits for both the companies or individuals running the studies, as well as ensuring the minimum possible time and number of patients are used in clinical studies to either prove (or disprove) the clinical efficacy of drugs or treatments.

This preferred system begins like most studies, with selection of target populations and administration of a regime according to an approved protocol. As data is collected, it is regularly cleaned. The cleaned data is then processed according to the algorithm(s) selected for use in the study, with the processing occurring according to a predetermined routine. If desired, statistical analysis can be continuously carried out on the clinical trial data while the clinical study is underway. Even though the data may not have reached the level to show a statistically significant difference, by use of the invention one can determine the predictive outcome (e.g., if and when the study is likely to reach that objective). Modifications to the protocol can be made on the fly if desirable, and even made part of the protocol based on predetermined thresholds.

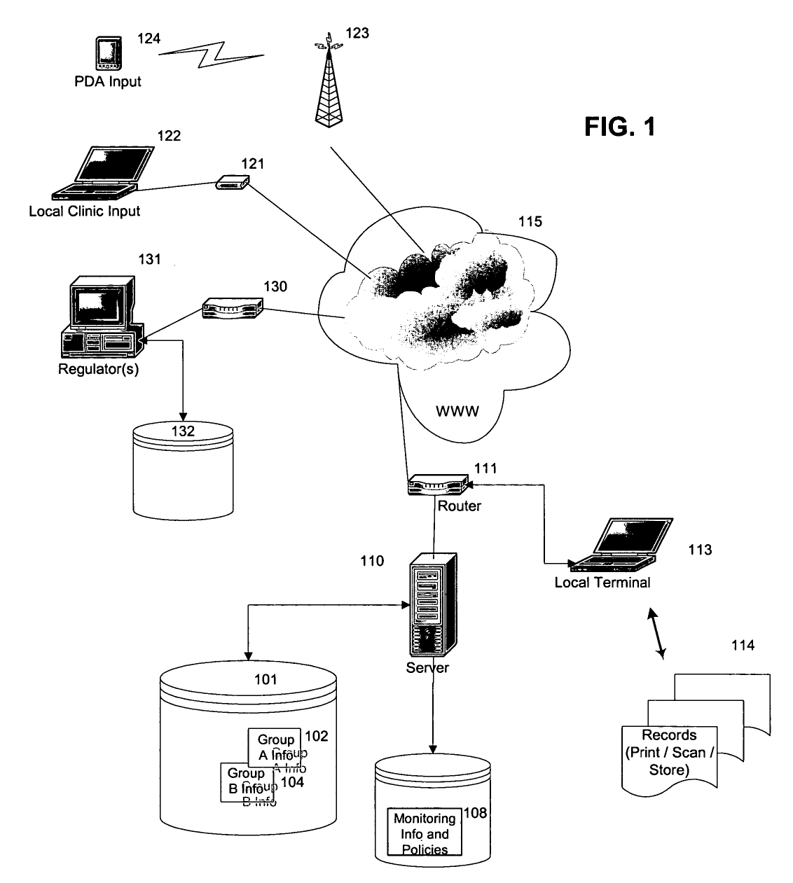

Turning first to FIG. 1, an overview is presented of some of the information technology components that can be found in a clinical trial system. At the core of each clinical trial is the trial data, shown in FIG. 1 as Group A table 102 and Group B table 104, both stored in database 101. Local terminal 113 is merely illustrative of any convenient data input device, whether a computer (via browser, applet, or other program), handheld device such as a personal digital assistant (PDA), processor or even scanner. In most trials this data is electronically input by medical providers or researchers at local or remote computers or other input devices 113, 122, 124. In some trials there may be the need to capture data in the form of written records, whether for convenience of local participant record keeping or data capture at remote facilities, and this written data is forwarded for input (e.g., records 114). Increasingly, remote data will be collected over a network, such as the internet 115, and wired or wireline networks 121, 123, and sent via router 111 to a local network and application server 110 that controls the databases 101 and 108. Also shown are the systems 130-132 of regulators, who may desire copies of the clinical statistical outcomes and/or test data, either at the end of the test, or at periodical intervals or even in real time.

As part of this improved system, the system software includes data base management policies, routines for cleaning data, and monitoring routines 108. The policies include restrictions placed on all or part of the data (such as access control constraints to keep the study blind), as well as the basic structure such as group membership, types of data and reports, etc. The cleaning routines include such features as prompts to insure data is input in a valid form, and all required data fields for a particular entry session or type are recorded. One of ordinary skill in the art will be able to either select from suitable commercially available software products tailored to clinical testing, or design their own using available database and program development tools such as those that ship with programs like Microsoft Access.

Unlike prior art systems, the improved system according to the invention includes an on-going study prediction package. In the preferred embodiment this package is a software module that can be loaded and periodically run in a local DBMS (data base management system) or application server 110. The functionality of this module is described in more detail below, and serves, among other things, to determine at predetermined intervals while a clinical study is being conducted whether the current population of participants is appropriate for achieving the objectives of the study. This may include the use of one or more thresholds, for example detecting when the statistical significance sought using the current population will exceed a high threshold (i.e., there are more participants than needed) or a low threshold (i.e., the number of participants is insufficient to achieve statistical significance).

Given the importance of maintaining the integrity of the data 102, 104 collected, appropriate levels of network security should be implemented, including authentication and access control based on a person's role in the trial (assigned according to the approved protocol by an administrator), firewalls, non-routable database IP addresses, encrypted data transfer (such as secure sockets layer (SSL) for remote browsers, or even encrypted databases), and the like. Further, although the clinical data has been illustrated as residing in two tables of the same database, the data may be stored in any convenient manner, in one or plural tables, in one or more physical locations, etc. All data may be relationally coupled to the database 101, or coupled via object or other database technologies. In addition, design templates, data rules and policies, and other administrative tools 108 are available to help implement robust protocols and data workflow to staff, researchers, and other interested parties. Similarly, the input and output devices are typically computers, but those skilled in the art will appreciate the choice of a given electronic, optical, mechanical, wired or wireless, etc. input, output, networking and processing devices are merely ones of system design choice, and the available choices will only increase as new and more portable devices are fielded each year. Thus, the structure is flexible enough to accommodate generic as well as unusual data architectures in support of the selected clinical study.

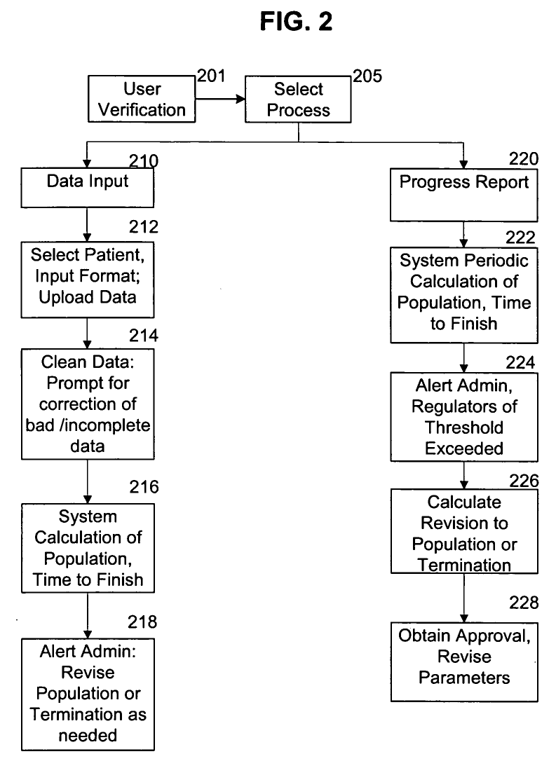

Turing now to FIG. 2, a process for regular or continuous statistical analysis according to a presently preferred embodiment of the invention is illustrated. Instead of relying on a sequence of processing steps on the entire data set (entering, cleaning, closing the set and analyzing the data) when the study is completed or at a single interim point, statistical analysis is carried out on a continuous basis throughout the study. The patient data is cleaned as it is captured (by means of logic checks throughout the data entry process), and this clean data is in turn available for periodic processing via a selected statistical program. Therefore, it is now possible to know at any moment what the statistical outcome of the study will be based upon the number of patients who have been entered into the study. Furthermore, it is also possible to make continual power calculations based upon the real data collected. Thus, as the study is on-going it is now possible to determine how many patients are required to reach statistical significance and predict when that will occur. Decisions can now be made to increase the number of patients in the study if required, decrease them, or even to stop the study early if statistical significance is reached with fewer patients than predicted, or if it appears that an excessive number of patients will be required to complete the study.

In order to accomplish this, data is first captured and entered according to the predetermined protocol established and approved for the study. This process is illustrated in part by the flow chart of FIG. 2. As noted above, this process differs significantly from prior approaches in that one can have the system either continually or regularly (i.e., at predetermined interval(s), or every time any or specific data types are entered) examine the current study data. This calculation is, in the preferred embodiment, done using the same algorithms and parameters approved for determining whether the protocol's objectives are met—e.g., determining when a study has reached a pre-determined level of statistical significance, and if not yet reached, predicting when this is likely to occur. Alternatively, variations are possible, such as using a higher level of statistical significance for the outcome before terminating the study earlier with a smaller population.

In the illustrated process of FIG. 2, a user begins by verifying (authenticating) themselves to the system, and selecting a data entry process (steps 201-210). Pertinent information about the participant(s) is then entered in the format specified by the protocol, using such well-known techniques as field- or menu-driven screens prompting the user to input required, available optional, fields (step 212). Because there are regular or continuous calculations run on the data, it is important that the data be cleaned on a regular basis. Preferably the input software is designed to facilitate this, prompting a user to correct any entries that are incomplete, inconsistent with expected trends, or otherwise outside of specified parameters for a given field (step 214). Alternatively, the data can be cleaned subsequently to initial entry by other users, with alerts being given to ensure the data is cleaned within a selected period of time. If the outcome is continuously monitored, raw data (i.e., that not yet cleaned) can be withheld without being used in any calculations, with an appropriate alert or notation added to any calculations that additional data is available but not yet applied. The actual cleaning may be done by commercially available software, or programmed as part of the data-entry prompts of the user front end for the DBMS program.

The preselected calculations are then performed on the participant data (step 216). The outcome data generated for a typical study will include several measures. These may include, but are not limited to: mean values; standard deviations; measures of statistical significance; and confidence intervals. Based on these measures, other desired outcome information is determined, such as the population needed (or desired at a given safety factor) and time before the study is expected to be finished. For significant changes, such as a reduction in the population needed, a requirement to increase the population being studied, and a satisfactory measure of statistical significance to end a study, an alert may be provided to both the local administrator as well as other interested parties (the study sponsors, regulators, and the like) (step 218). If pre-approved as part of the protocol within specified limits, the study can be changed on the fly. Otherwise, an application can be made to the regulators to modify the protocol in view of this predictive data.

Those skilled in the art will appreciate that the on-going analysis can be carried out with a number of different protocol and statistical techniques. It can, for example, be carried out on a blinded basis, where the treatment each subject is receiving is not identified in the database. Alternatively, it can be done on a non-blinded basis where the treatment each subject is receiving is identified in the database.

At the beginning of the trial, the study sponsor will choose which method they want to use, including their choice of statistical routines that they wish to use as a measure of differentiating the trial drug(s) from placebo or comparator (as applicable). The routines may come from an existing bank of 10 to 20 routines (such as available in SAS/STAT from the SAS Institute), or if the data is more complex, other routines may be added. These routines will typically be used throughout the entire study. The variables determining the primary outcome(s) will be identified, and the statistical routines will be applied to these variables. However, the method by which the data is analyzed is very flexible, and will depend upon the particular requirements initially set by the study sponsor.

Randomization codes (A, B, C, D, E, etc.) may be included in the electronic data capture system so that the statistical routines can be measured by each arm. As noted above, this can be done in a blinded manner (so that it is not known which treatment each group represents). Although the packages for each arm of the study will be identified by this method, no member of the team will know which of each of the arms is the active compound, the comparator or the placebo. Alternatively, this can be done in a non-blinded manner (where each group is known to mean a particular treatment), and subsequent access to this data can be controlled as required (for example, a team not linked to the study directly may have access, or a data safety monitoring board may have access).

As with other systems, data will be continually entered into the electronic data capture system. This will continue throughout the course of the study. On a periodic basis identified by the sponsor (real-time, after a certain number of patients, nightly, weekly, bi-weekly, etc.), the data is analyzed against the data included in the database using the routines chosen (steps 220-228). Once calculated, the study sponsor will be in a position to know when the trial has reached statistically significant difference at an acceptable confidence interval, when too many patients are required to reach a statistically valid conclusion (sometimes indicating that the trial is not economically feasible), when a lesser number of participants are needed to complete the study, more or less time, and the like.

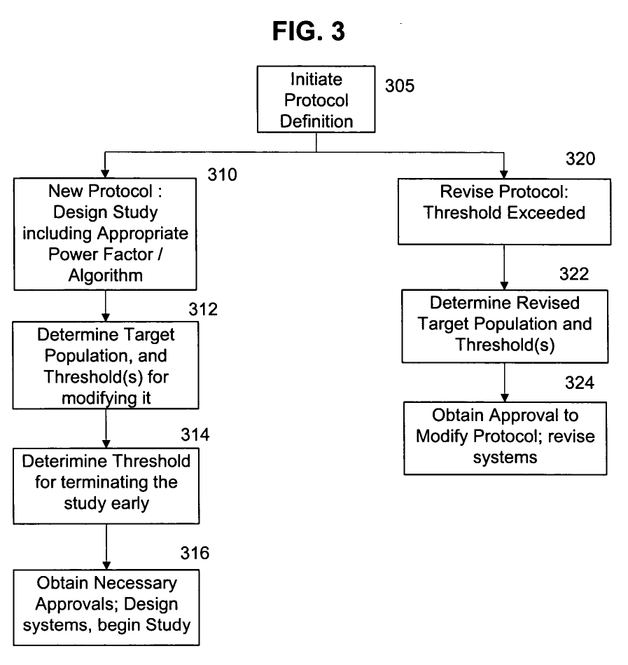

FIG. 3 illustrates a process for including a predictive outcome step as part of the study protocol. Depending on the type of study being undertaken, the sponsor will select an optimal design for the study, including power factors/algorithm(s) to be used in determining whether there is statistical significance in the data collected (steps 305-310). In current studies, there is no additional provision for modes of analyzing data during a study, and the sponsor proceeds to obtain necessary regulatory approvals to begin the study (step 316). If analysis is performed on the data during the study, changes to the protocol may trigger the need to go back in for approval of the modifications to the study (steps 320-324). However, as long as the regulators are satisfied that the integrity of the study is safeguarded while performing ongoing analysis, the original protocol can be developed with pre-approved alternatives for modifying the study based on the outcome of ongoing analyses (step 314-316). Thus, in addition to selecting an initial target population for the groups being studied, thresholds can be established beforehand based on the likely range of outcomes needed to adjust key aspects of the ongoing study (e.g., lowering or raising the population), or terminating the study early (e.g., when a target level of statistical significance is reached, or alternatively when none is likely to be reached).

This also facilitates the study of uneven population groups. For example, if the initial protocol establishes a comparator group at one third the size of the group receiving a new drug, a double blind study can still be run by sectioning the test group into three equal groups A-C, with the comparator group designated as group D. If in the course of the study the analysis crosses a first probability threshold, indicating that a statistically significant outcome will be achieved with a reduced test population, testing on an entire group (say group B) can be terminated without in any way inferring the composition of the remaining groups. Because this possible outcome can be readily determined using the same analytics being used for the final analysis of the study, these early termination thresholds can be made part of the initial protocol without in any way compromising the blind nature of a study. In similar way, other protocol modifications (e.g., adding a group to reach a target statistical outcome or date for conclusion of the study) can be planned as part of the initial protocol, obviating the need to obtain additional approvals for changes in the protocol.

While it is envisaged that the major use of this process will be in the larger Phase III and Phase IV studies, it may also be used in Phase I and Phase II studies, and similar clinical studies for other regulatory agencies

Of course, one skilled in the art will appreciate how a variety of alternatives are possible for the individual elements, and their arrangement, described above, while still falling within the scope of the invention. Thus, while it is important to note that the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of signal bearing media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The signal bearing media may take the form of coded formats that are decoded for actual use in a particular data processing system.

In conclusion, the above description has been presented for purposes of illustration and description of an embodiment of the invention, but is not intended to be exhaustive or limited to the form disclosed. This embodiment was chosen and described in order to explain the principles of the invention, show its practical application, and to enable those of ordinary skill in the art to understand how to make and use the invention. Many modifications and variations will be apparent to those of ordinary skill in the art. Thus, it should be understood that the invention is not limited to the embodiments described above, but should be interpreted within the full spirit and scope of the appended claims.

We claim:

1. A method for control of human clinical trials, comprising:
(a) establishing a protocol for the clinical trial, including a test objective and statistical measures to assess the test objective;
(b) initiating the clinical trial, including obtaining test data from a test population;
(c) validating that the test data is clean data, and storing the clean data in a clinical trial data store; and
(d) retrieving the clean data on a predetermined basis and in a processor applying at least one of the statistical measures while the clinical trial is on-going to determine value of one or more parameters about the statistical significance of the clean data to the test objective.

2. The method of claim 1, wherein said parameters comprise one of the group of an estimated time for a selected population level at which a statistically significant result will be achieved, a population level required to achieve a selected level of statistical significance, an estimated statistical outcome level for the selected population level, the estimated date on which the clinical trial can be terminated, and an estimate whether a statistically significant result will be achieved in the clinical trial.

3. The method of claim 2, wherein the step of determining in step (d) comprises comparing the parameters against at least one predetermined threshold, and providing a message to a user if the threshold is exceeded.

4. The method of claim 2, further comprising:
(e) modifying one of the group of the number of the test population and the termination date of the study in response to the determined value of one of the parameters.

5. The method of claim 4, wherein the test population comprises at least three groups, and step (e) comprises terminating one of the groups from further testing.

6. The method of claim 5, wherein step (a) comprises designing the protocol to include a first group and a second set of groups, each group of the second set of groups having the same population as the first group, where either the first group or the second set of groups is a test population for a new drug and the other is a comparison population, the protocol further including at least one option for modifying the second set of groups by adding or dropping a group of the set of groups in response to the determined value of one of the parameters.

7. The method of claim 1, wherein the predetermined basis of step (d) comprises one of the group of retrieving the data: on programmed intervals of one of the group of daily, weekly, bi-weekly and monthly; on programmed intervals of time; on preselected dates; when the clean data in the data store is modified by changes or additions of new clean data; and when prompted by an approved user.

8. The method of claims 1, wherein step (c) comprises validating the test data as a user enters new test data by comparing a data entry against one of the group of preselected valid entries, a range of probable entries, prior data for consistency, and a list of required fields.

9. The method of claim 1, wherein step (a) comprises designing the protocol to include at least one option for modifying one of the group of the number of the test population and the termination date of the study in response to the determined value of one of the parameters.

10. An information handling system for use in determining the efficacy of drugs in human clinical trials, comprising a processor and a statistical tool for determining a level by which test data shows efficacy of a drug, the statistical tool comprising plural instructions and the processor operably configured to execute said plural instructions, the plural instructions comprising:
(a) data capture instructions operable for validating that the test data is clean data, and storing the clean data in a clinical trial data store; and
(b) statistical measure instructions operable for retrieving the clean data on a predetermined basis and in a processor applying at least one of the statistical measures while the clinical trial is on-going to determine value of one or more parameters about the statistical significance of the clean data to the test objective.

11. The information handling system of claim 10, wherein the statistical measure instructions are further configured to determine a value of said parameters from one of the group of an estimated time for a selected population level at which a statistically significant result will be achieved, a population level required to achieve a selected level of statistical significance, an estimated statistical outcome level for the selected population level, the estimated date on which the clinical trial can be terminated, and an estimate whether a statistically significant result will be achieved in the clinical trial.

12. The information handling system of claim 11, wherein the statistical measure instructions are further operable for comparing said value against at least one predetermined threshold, and providing a message to a user if the threshold is exceeded.

13. The information handling system of claim 11, further comprising:
(c) notice instructions operable for messaging a user to modify one of the group of the number of the test population and the termination date of the study in response to the determined value of one of the parameters by the statistical measure instructions.

14. The information handling system of claim 13, wherein the clinical trial includes at least three groups, and the notice instructions are further operable for prompting a user to terminate one of the groups from further testing.

15. The information handling system of claim 10, wherein the statistical measure instructions are further operable to apply said at least one statistical measure on the predetermined basis, the predetermined basis consisting of one of the group of retrieving the data: on programmed intervals of one of the group of daily, weekly, bi-weekly and monthly; on programmed intervals of time; on preselected dates; when the clean data in the data store is modified by changes or additions of new clean data; and when prompted by an approved user.

16. The information handling system of claim 10, wherein the data capture instructions are further operable to validate the test data as a user enters new test data by comparing a data entry against one of the group of preselected valid entries, a range of probable entries, prior data for consistency, and a list of required fields.

17. The information handling system of claim 10, wherein step (a) comprises designing the protocol to include at least one option for modifying one of the group of the number of the test population and the termination date of the study in response to the determined value of one of the parameters.

18. A program product in signal bearing media executable by a device for use in determining the efficacy of drugs in human clinical trials, the product comprising plural instructions controlling operation of a processor, the plural instructions comprising:
(a) data capture instructions operable for validating that the test data is clean data, and storing the clean data in a clinical trial data store; and
(b) statistical measure instructions operable for retrieving the clean data on a predetermined basis and in a processor applying at least one of the statistical measures while the clinical trial is on-going to determine value of one or more parameters about the statistical significance of the clean data to the test objective.

19. The program product of claim 18, wherein the statistical measure instructions are further operable to determine a value of said parameters from one of the group of an estimated time for a selected population level at which a statistically significant result will be achieved, a population level required to achieve a selected level of statistical significance, an estimated statistical outcome level for the selected population level, the estimated date on which the clinical trial can be terminated, and an estimate whether a statistically significant result will be achieved in the clinical trial; wherein the statistical measure instructions are further operable for comparing said value against at least one predetermined threshold, and informing a user if the threshold is exceeded.

20. A method to minimize the time and number of participants required for human clinical trials, comprising:
(a) establishing a protocol for the clinical trial, including a test objective and statistical measures to assess the test objective, the protocol comprising at least one option for modifying one of the group of the number of the test population and a termination date of the study in response to application of one of the statistical measures while the clinical trial is on-going to determine value of one or more parameters about the statistical significance of validated data obtained during a test to the test objective.

21. The method of claim 20, further comprising:
(b) initiating the clinical trial, including obtaining test data from a test population;
(c) validating that the test data is clean data, and storing the clean data as validated data in a clinical trial data store; and
(d) retrieving the clean data on a predetermined basis and in a processor applying at least one of the statistical measures while the clinical trial is on-going to determine the value of one or more parameters about the statistical significance of the clean data to the test objective.
